(19) United States
(12) Patent Application Publication
(10) Pub. No.: US 2008/0207823 A1
(43) Pub. Date: Aug. 28, 2008

(54) Active Compositions And Methods

(75) Inventors: Daniel David Lecloux, Wilmington, DE (US); Matthew Stainer, Goleta, CA (US); Eric Maurice Smith, Hockessin, DE (US); Reid John Chesterfield, Wilmington, DE (US); Shiva Prakash, Santa Barbara, CA (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: E.I. du Pont de Nemours and Company, Wilmington, DE (US)

(21) Appl. No.: 11/722,124

(22) PCT Filed: Dec. 28, 2005
(86) PCT No.: PCT/US05/47475

§ 371 Date: Jun. 27, 2007

Related U.S. Application Data
(60) Provisional application No. 60/640,393, filed on Dec. 29, 2004.
(60) Provisional application No. 60/694,399, filed on Jun. 27, 2005.

(51) Int. Cl. C08L 27/12

(52) U.S. Cl. 524/545

(57) ABSTRACT

The present concerns a method of fabricating a layer for an organic light emitting device comprising solution processing a layer from a solution comprising a small molecule emissive material, an aprotic solvent, and a polymeric material.

### CROSS REFERENCE

This application claims benefit to U.S. Provisional Application Ser. Nos. 60/640,393, filed Dec. 29, 2004 and 60/694,399, filed Jun. 27, 2005, the disclosures of which are each incorporated herein by reference in their entireties.

### FIELD

This disclosure relates generally to active compositions, for example, those found in organic electronic devices, and materials and methods for fabrication of the same.

### BACKGROUND

Organic electronic devices convert electrical energy into radiation, detect signals through electronic processes, convert radiation into electrical energy, or include one or more organic semiconductor layers. Most organic electronic devices are made up of a series of layers. It is desirable to prepare these multilayer, patterned structures via additive processes, especially printing processes, to reduce material waste and process complexity.

Organic electronic devices include at least one active layer, however, the active layers can be fragile, and device resolution is negatively affected if the layer becomes non-uniform, for example during printing.

Thus, what is needed are active compositions, methods for making the same, as well as devices and sub-assemblies including the same.

### SUMMARY

In one embodiment, compositions are provided comprising small molecule active material, polymer, and aprotic solvent, and methods for making the same, as well as devices and sub-assemblies including the same.

The foregoing general description and the following detailed description are exemplary and explanatory only and are not restrictive of the invention, as defined in the appended claims.

### BRIEF DESCRIPTION OF THE DRAWINGS

Embodiments are illustrated in the accompanying figures to improve understanding of concepts as presented herein.

FIG. 1 is a schematic diagram of an organic electronic device.

The figures are provided by way of example and are not intended to limit the invention. Skilled artisans appreciate that objects in the figures are illustrated for simplicity and clarity and have not necessarily been drawn to scale. For example, the dimensions of some of the objects in the figures may be exaggerated relative to other objects to help to improve understanding of embodiments.

### DETAILED DESCRIPTION

In one embodiment, compositions are provided, comprising a small molecule active material; polymer; and aprotic solvent.

The term “small molecule,” when referring to a compound, is intended to mean a compound which does not have repeating monomeric units. In one embodiment, a small molecule has a molecular weight no greater than approximately 2000 g/mol. The term “active material” refers to a material which electronically facilitates the operation of the device, either emitting radiation or exhibiting a change in concentration of electron-hole pairs when receiving radiation. Examples of active materials include, but are not limited to, materials which conduct, inject, transport, or block a charge, where the charge can be either an electron or a hole.

In one embodiment, the small molecule active material is a photoactive material. In one embodiment, the small molecule active material is fluorescent. In one embodiment, the small molecule active material is an organometallic complex. In one embodiment, the small molecule active material is any conventional blue, green, or red emitter, or mixtures thereof. In one embodiment, the small molecule active material includes a host and dopant combination.

In one embodiment, the small molecule active material includes an anthracene derivative. In one embodiment, the small molecule active material includes carbazoles, metallated phenylpyridines, phenylquinolines, phenylisoquinolines, anthracenes, aminostyrenes, aminochrysenes, aminoperylenes, aminonapthalines, aminoanthracenes, aminopyrenes, styrylarylenes, or mixtures thereof.

In one embodiment, the small molecule active material includes:

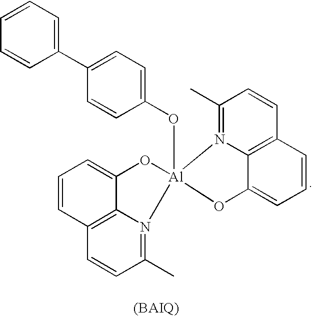

In one embodiment, small molecule active material includes:

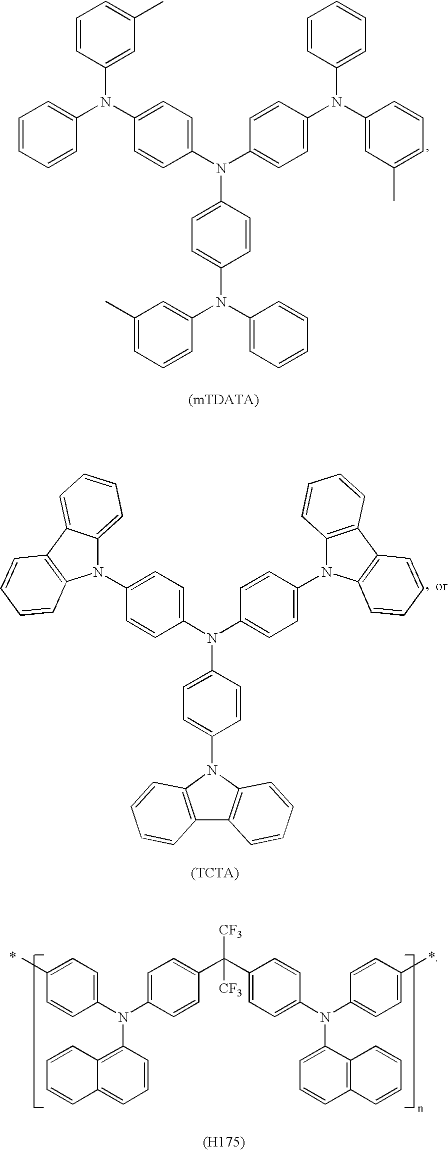

In one embodiment, the small molecule active material includes arylamine derivatives.

In one embodiment, the small molecule active material includes:

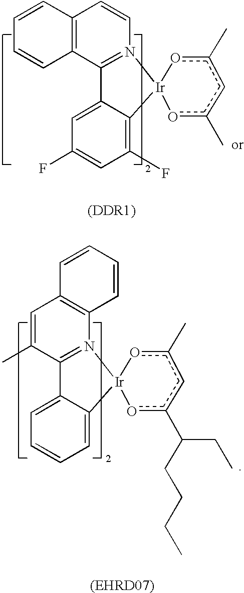

In one embodiment, the small molecule active material is a mixture of hosts and a dopant as follows in TABLE 1.

TABLE 1

| Host A | Host B | A:B | Dopant |
|---|---|---|---|
| BAIQ | mTDATA | 2:1 | DDR1 |
| BAIQ | mTDATA | 4:1 | DDR1 |
| BAIQ | TCTA | 2:1 | DDR1 |
| BAIQ | H175 | 2:1 | DDR1 |
| BAIQ | H175 | 4:1 | DDR1 |
| BAIQ | mTDATA | 4:1 | EHRD07 |
| BAIQ | TCTA | 4:1 | EHRD07 |
| BAIQ | H175 | 4:1 | EHRD07 |

In one embodiment, the small molecule active material is present in a range of about 0.5 percent to about 30 percent by weight of the composition. In one embodiment, the small molecule active material is present in a range of about 1 percent to about 20 percent by weight of the composition. In one embodiment, the small molecule active material is present in a range of about 2 percent to about 10 percent by weight of the composition.

In one embodiment, the small molecule active material is a charge transport material. In one embodiment, the charge transport material is a small molecule hole transport material. In one embodiment, the charge transport material includes derivatives of triarylamine, thiophenes, or combinations thereof.

In one embodiment, the polymer has a molecular weight of at least 100,000, and optionally, at least 200,000. In one embodiment, the polymer is one that avoids phase separation upon removal of the solvent. It can readily be understood that phase separation undesirably disturbs the integrity of the layer.

In one embodiment, the polymer is polyfluorene, polyspirofluorene, polystyrene, polyethylene, poly[2,2-diphenyl-(hexafluoroisopropylidene)-4,4′-diyl], polyspirofluorene AEF 2544, a copolymer of 2,2-diphenyl-(hexafluoroisopropylidene)-4,4′-diyl and a dialkyl fluorine, poly(vinylquinoxaline), or mixtures thereof.

In one embodiment, the polymer is present in a range of about 1 percent to about 20 percent by weight of the composition. In one embodiment, the polymer is present in a range of about 5 percent to about 15 percent by weight of the composition.

In one embodiment, the aprotic solvent is one that solubilizes both the small molecule emissive material and the polymeric additive in a stable blend. In one embodiment, the aprotic solvent is aromatic hydrocarbon, toluene, xylene, mesitylene, anisole, chlorobenzene, cyclohexanone, gamma-valerolactone, chloroform, derivatives thereof, or mixtures thereof.

In one embodiment, the solvent has a boiling range (at atmospheric pressure) between about 70 and about 250° C.

In one embodiment, the viscosity of the composition is in a range of about 0.1 to about 100 centipoise.

In one embodiment, methods for improving the uniformity of an active layer containing small molecules are provided, comprising adding a polymer to the active layer composition before deposition.

In one embodiment, the polymer has a molecular weight of at least 100,000, and optionally, at least 200,000. In one embodiment, the polymer is one that avoids phase separation upon removal of the solvent. In one embodiment, the polymer is polyfluorene, polyspirofluorene, polystyrene, polyethylene, poly[2,2-diphenyl-(hexafluoroisopropylidene)-4,4′-diyl], polyspirofluorene AEF 2544, a copolymer of 2,2-diphenyl-(hexafluoroisopropylidene)-4,4′-diyl and a dialkyl fluorine, poly(vinylquinoxaline), or mixtures thereof.

In one embodiment, the polymer is present in a range of about 1 percent to about 20 percent by weight of the composition. In one embodiment, the polymer is present in a range of about 5 percent to about 15 percent by weight of the composition.

In one embodiment, a method for improving the deposition of an active layer containing small molecules is provided, comprising adding a polymer to the active layer composition before deposition.

In one embodiment, compositions are provided comprising the above-described compounds and at least one solvent, processing aid, charge transporting material, or charge blocking material. These compositions can be in any form, including, but not limited to solvents, emulsions, and colloidal dispersions.

### Device

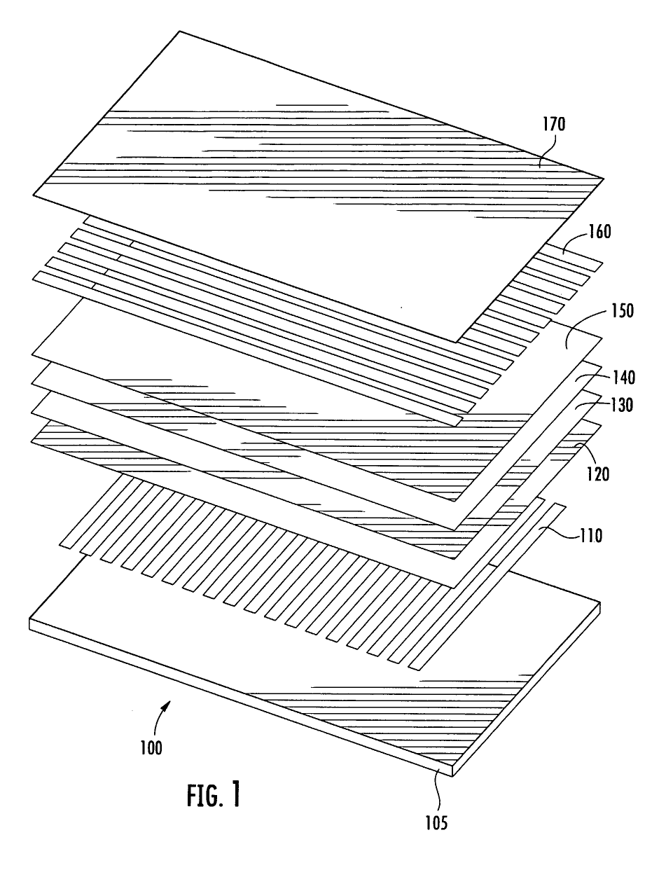

Referring to FIG. 1, an exemplary organic electronic device 100 is shown. The device 100 includes a substrate 105. The substrate 105 may be rigid or flexible, for example, glass, ceramic, metal, or plastic. When voltage is applied, emitted light is visible through the substrate 105.

A first electrical contact layer 110 is deposited on the substrate 105. For illustrative purposes, the layer 110 is an anode layer. Anode layers may be deposited as lines. The anode can be made of, for example, materials containing or comprising metal, mixed metals, alloy, metal oxides or mixed-metal oxide. The anode may comprise a conducting polymer, polymer blend or polymer mixtures. Suitable metals include the Group 11 metals, the metals in Groups 4, 5, and 6, and the Group 8, 10 transition metals. If the anode is to be light-transmitting, mixed-metal oxides of Groups 12, 13 and 14 metals, such as indium-tin-oxide, are generally used. The anode may also comprise an organic material, especially a conducting polymer such as polyaniline, including exemplary materials as described in Flexible Light-Emitting Diodes Made From Soluble Conducting Polymer, Nature 1992, 357, 477-479. At least one of the anode and cathode should be at least partially transparent to allow the generated light to be observed.

An optional buffer layer 120, such as hole transport materials, may be deposited over the anode layer 110, the latter being sometimes referred to as the “hole-injecting contact layer.” Examples of hole transport materials suitable for use as the layer 120 have been summarized, for example, in Kirk Othmer, Encyclopedia of Chemical Technology, Vol. 18, 837-860 (4^{th} ed. 1996). Both hole transporting “small” molecules as well as oligomers and polymers may be used. Hole transporting molecules include, but are not limited to: N,N′ diphenyl-N,N′-bis(3-methylphenyl)-[1,1′-biphenyl]-4,4′-diamine (TPD), 1,1 bis[(di-4-tolylamino) phenyl]cyclohexane (TAPC), N,N′ bis(4-methylphenyl)-N,N′-bis(4-ethylphenyl)-[1,1 ′-(3,3′-dimethyl)biphenyl]-4,4′-diamine (ETPD), tetrakis (3-methylphenyl)-N,N,N′,N′-2,5-phenylenediamine (PDA), a-phenyl 4-N,N-diphenylaminostyrene (TPS), p (diethylamino)benzaldehyde diphenylhydrazone (DEH), triphenylamine (TPA), bis[4 (N,N-diethylamino)-2-methylphenyl](4-methylphenyl)methane (MPMP), 1 phenyl-3-[p-(diethylamino)styryl]-5-[p-(diethylamino)phenyl] pyrazoline (PPR or DEASP), 1,2 trans-bis(9H-carbazol-9-yl)cyclobutane (DCZB), N,N,N′,N′ tetrakis(4-methylphenyl)-(1,1′-biphenyl)-4,4′-diamine (TTB), and porphyrinic compounds, such as copper phthalocyanine. Useful hole transporting polymers include, but are not limited to, polyvinylcarbazole, (phenylmethyl)polysilane, and polyaniline. Conducting polymers are useful as a class. It is also possible to obtain hole transporting polymers by doping hole transporting moieties, such as those mentioned above, into polymers such as polystyrenes and polycarbonates.

An organic layer 130 may be deposited over the buffer layer 120 when present, or over the first electrical contact layer 110. In some embodiments, the organic layer 130 may be a number of discrete layers comprising a variety of components. Depending upon the application of the device, the organic layer 130 can be a light-emitting layer that is activated by an applied voltage (such as in a light-emitting diode or light-emitting electrochemical cell), or a layer of material that responds to radiant energy and generates a signal with or without an applied bias voltage (such as in a photodetector).

Other layers in the device can be made of any materials which are known to be useful in such layers upon consideration of the function to be served by such layers.

Any organic electroluminescent (“EL”) material can be used as a photoactive material (e.g., in layer 130). Such materials include, but are not limited to, fluorescent dyes, small molecule organic fluorescent compounds, fluorescent and phosphorescent metal complexes, conjugated polymers, and mixtures thereof. Examples of fluorescent dyes include, but are not limited to, pyrene, perylene, rubrene, derivatives thereof, and mixtures thereof. Examples of metal complexes include, but are not limited to, metal chelated oxinoid compounds, such as tris(8-hydroxyquinolato)aluminum (Alq3); cyclometalated iridium and platinum electroluminescent compounds, such as complexes of Iridium with phenylpyridine, phenylquinoline, or phenylpyrimidine ligands as disclosed in Petrov et al., Published PCT Application WO 02/02714, and organometallic complexes described in, for example, published applications US 2001/0019782, EP 1191612, WO 02/15645, and EP 1191614; and mixtures thereof. Electroluminescent emissive layers comprising a charge carrying host material and a metal complex have been described by Thompson et al., in U.S. Pat. No. 6,303,238, and by Burrows and Thompson in published PCT applications WO 00/70655 and WO 01/41512. Examples of conjugated polymers include, but are not limited to poly(phenylenevinylenes), polyfluorenes, poly(spirobifluorenes), polythiophenes, poly(p-phenylenes), copolymers thereof, and mixtures thereof.

In one embodiment of the devices of the invention, photoactive material can be an organometallic complex. In another embodiment, the photoactive material is a cyclometalated complex of iridium or platinum. Other useful photoactive materials may be employed as well. Complexes of iridium with phenylpyridine, phenylquinoline, or phenylpyrimidine ligands have been disclosed as electroluminescent compounds in Petrov et al., Published PCT Application WO 02/02714. Other organometallic complexes have been described in, for example, published applications US 2001/0019782, EP 1191612, WO 02/15645, and EP 1191614. Electroluminescent devices with an active layer of polyvinyl carbazole (PVK) doped with metallic complexes of iridium have been described by Burrows and Thompson in published PCT applications WO 00/70655 and WO 01/41512. Electroluminescent emissive layers comprising a charge carrying host material and a phosphorescent platinum complex have been described by Thompson et al., in U.S. Pat. No. 6,303,238, Bradley et al., in Synth. Met. 2001, 116 (1-3), 379-383, and Campbell et al., in Phys. Rev. B, Vol. 65 085210.

A second electrical contact layer 160 is deposited on the organic layer 130. For illustrative purposes, the layer 160 is a cathode layer.

Cathode layers may be deposited as lines or as a film. The cathode can be any metal or nonmetal having a lower work function than the anode. Exemplary materials for the cathode can include alkali metals, especially lithium, the Group 2 (alkaline earth) metals, the Group 12 metals, including the rare earth elements and lanthanides, and the actinides. Materials such as aluminum, indium, calcium, barium, samarium and magnesium, as well as combinations, can be used. Lithium-containing and other compounds, such as LiF and Li₂O, may also be deposited between an organic layer and the cathode layer to lower the operating voltage of the system.

An electron transport layer 140 or electron injection layer 150 is optionally disposed adjacent to the cathode, the cathode being sometimes referred to as the “electron-injecting contact layer.”

An encapsulation layer 170 is deposited over the contact layer 160 to prevent entry of undesirable components, such as water and oxygen, into the device 100. Such components can have a deleterious effect on the organic layer 130. In one embodiment, the encapsulation layer 170 is a barrier layer or film.

Though not depicted, it is understood that the device 100 may comprise additional layers. For example, there can be a layer (not shown) between the anode 110 and hole transport layer 120 to facilitate positive charge transport and/or band-gap matching of the layers, or to function as a protective layer. Other layers that are known in the art or otherwise may be used. In addition, any of the above-described layers may comprise two or more sub-layers or may form a laminar structure. Alternatively, some or all of anode layer 110 the hole transport layer 120, the electron transport layers 140 and 150, cathode layer 160, and other layers may be treated, especially surface treated, to increase charge carrier transport efficiency or other physical properties of the devices. The choice of materials for each of the component layers is preferably determined by balancing the goals of providing a device with high device efficiency with device operational lifetime considerations, fabrication time and complexity factors and other considerations appreciated by persons skilled in the art. It will be appreciated that determining optimal components, component configurations, and compositional identities would be routine to those of ordinary skill of in the art.

In one embodiment, the different layers have the following range of thicknesses: anode 110, 500-5000 Å, in one embodiment 1000-2000 Å; hole transport layer 120, 50-2000 Å, in one embodiment 200-1000 Å; photoactive layer 130, 10-2000 Å, in one embodiment 100-1000 Å; layers 140 and 150, 50-2000 Å, in one embodiment 100-1000 Å; cathode 160, 200-10000 Å, in one embodiment 300-5000 Å. The location of the electron-hole recombination zone in the device, and thus the emission spectrum of the device, can be affected by the relative thickness of each layer. Thus the thickness of the electron-transport layer should be chosen so that the electron-hole recombination zone is in the light-emitting layer. The desired ratio of layer thicknesses will depend on the exact nature of the materials used.

In operation, a voltage from an appropriate power supply (not depicted) is applied to the device 100. Current therefore passes across the layers of the device 100. Electrons enter the organic polymer layer, releasing photons. In some OLEDs, called active matrix OLED displays, individual deposits of photoactive organic films may be independently excited by the passage of current, leading to individual pixels of light emission. In some OLEDs, called passive matrix OLED displays, deposits of photoactive organic films may be excited by rows and columns of electrical contact layers.

Devices can be prepared employing a variety of techniques. These include, by way of non-limiting exemplification, vapor deposition techniques and liquid deposition. Devices may also be sub-assembled into separate articles of manufacture that can then be combined to form the device.

### Definitions

The use of “a” or “an” are employed to describe elements and components of the invention. This is done merely for convenience and to give a general sense of the invention. This description should be read to include one or at least one and the singular also includes the plural unless it is obvious that it is meant otherwise.

The term “active” when referring to a layer or material is intended to mean a layer or material that exhibits electronic or electro-radiative properties. An active layer material may emit radiation or exhibit a change in concentration of electron-hole pairs when receiving radiation. Thus, the term “active material” refers to a material which electronically facilitates the operation of the device. Examples of active materials include, but are not limited to, materials which conduct, inject, transport, or block a charge, where the charge can be either an electron or a hole. Examples of inactive materials include, but are not limited to, planarization materials, insulating materials, and environmental barrier materials.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “layer” is used interchangeably with the term “film” and refers to a coating covering a desired area. The area can be as large as an entire device or a specific functional area such as the actual visual display, or as small as a single sub-pixel. Films can be formed by any conventional deposition technique, including vapor deposition and liquid deposition. Liquid deposition techniques include, but are not limited to, continuous deposition techniques such as spin coating, gravure coating, curtain coating, dip coating, slot-die coating, spray-coating, and continuous nozzle coating; and discontinuous deposition techniques such as ink jet printing, gravure printing, and screen printing.

The term “organic electronic device” is intended to mean a device including one or more semiconductor layers or materials. Organic electronic devices include, but are not limited to: (1) devices that convert electrical energy into radiation (e.g., a light-emitting diode, light emitting diode display, diode laser, or lighting panel), (2) devices that detect signals through electronic processes (e.g., photodetectors photoconductive cells, photoresistors, photoswitches, phototransistors, phototubes, infrared (“IR”) detectors, or biosensors), (3) devices that convert radiation into electrical energy (e.g., a photovoltaic device or solar cell), and (4) devices that include one or more electronic components that include one or more organic semiconductor layers (e.g., a transistor or diode). The term device also includes coating materials for memory storage devices, antistatic films, biosensors, electrochromic devices, solid electrolyte capacitors, energy storage devices such as a rechargeable battery, and electromagnetic shielding applications.

The term “substrate” is intended to mean a workpiece that can be either rigid or flexible and may include one or more layers of one or more materials, which can include, but are not limited to, glass, polymer, metal, or ceramic materials, or combinations thereof.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the organic light-emitting diode display, photodetector, photovoltaic, and semiconductive member arts.

### EXAMPLES

The concepts described herein will be further described in the following examples, which do not limit the scope of the invention described in the claims.

### Example 1

A solution of the small molecule emissive material, blue host (commercially available from Idemitsu as BH140) and blue dopant (commercially available from Idemitsu as BD52) in a 13:1 ratio, dissolved in anisole to 2.5% weight of solids to solvent volume was made, into which 10% of polymeric additive in the form of powder was dissolved. The resultant solution was filled into an inkjet nozzle of a Microfab inkjet printer model JetLab. A row of pixels on a wafer was aligned to the nozzle, and the solution was ink-jetted into the pixels. In the comparative example, no polymeric additive was present. The compositions and the printing conditions are summarized below in Table 2.

TABLE 2

| | Comparative | | Example 1 | |
|---|---|---|---|---|
| % Small molecule in organic | 2.5% | | 2.5% | |
| solvent | | | | |
| % Polymeric additive (solids | 0% | | 10% | |
| basis) | | | | |
| Organic solvent | Anisole | | Anisole | |
| Drop volume | 20-30 | pico L | 20-30 | pico L |
| Drop spacing | 50-90 | microns | 50-90 | microns |
| Stage (wafer) temperature | 25-60° | C. | 25-60° | C. |

After the film was formed by solvent evaporation, another pass was printed on an adjacent row. Over a 2-dimensional area with many rows, the second printing is called interleaving printing. In the comparative example, when no polymer additive was present, the first pass printed areas were disrupted after the second pass. The edges were eroded and uneven and the areas were non-uniform. In the sample of Example 1, the first pass areas were undisturbed after the second pass. The films remained uniform and even.

### Example 2

Following the procedures and the materials of Example 1, a film or emissive layer is formed; however, polyspirofluorene AEF 2544 (Covion Organic Semiconductors GmbH, Frankfurt, Germany) is used as the polymeric additive.

### Example 3

Following the procedures and the materials of Example 1, a film or emissive layer is formed; however, poly[2,2-diphenyl-(hexafluoroisopropylidene)-4,4′-diyl] is used as the polymeric additive.

### Example 4

Following the procedures and the materials of Example 1, a film or emissive layer is formed; however, poly(vinylquinoxaline) is used as the polymeric additive.

### Example 5

Following the procedures and the materials of Example 1, a film or emissive layer is formed; however, a blue polyfluorene is used as the polymeric additive.

### Example 6

Two controls, and three pairs of devices with ˜2.0,10.0, and 20% w/w polystyrene (PS Mw ˜1.9M) in the emissive layer were formed, respectively. A blue dopant to host ratio of 1:13 was used. The device architecture was indium tin oxide (ITO)/buffer layer (polythiophene with fluorinated sulfonic acid copolymers)/hole transport layer (HT12 commercially available from Dow Chemical)/emissive layer as described above/Tetrakis-(8-hydroxyquinoline) zirconium (ZrQ)/LiF/Al.

The IV traces showed that below 4:1 there is little change in the conductivity of the EML with PS addition. However, at 4:1 there is a significant voltage shift, indicating a higher resistance. The efficiencies, and color coordinates in all cases were similar, but with slight shifts indicating that the PS causes the EML to be more electron dominated, as indicated by increasingly steeper negative slope in the CE vs. L plot. LT data shows a monotonic effect on lifetime with amount of PS added. At 9:1 a sample is estimated to have t50˜900 hrs, compared to controls and 49:1 with t50˜1400 hrs. This indicates a compromise with small amounts of PS may be acceptable particularly if small amounts of hole transporter are added to the EML to offset any hole transport loss. Experimentation on the hole electron balance will likely find a longer lifetime architecture with higher amounts of PS.

### Example 7

Conditions similar to Example 6 were used, however, a red dopant and host [BalQ:H694 (4:1)]:R482(92:8)] in the emissive layer (EML) replace the blue.

The IV traces show that below 4:1 addition there is little change in the conductivity of the EML with PS addition. However, at 4:1 there is a significant voltage shift, indicating a higher resistance. The color coordinates in all devices were similar to within 0.002 in X and Y. The efficiency of the devices is scattered with PS addition, perhaps because the EML thickness was not identical. Alternatively, altering the conductivity of the EML may improve the efficiency of this phosphorescent system. No obvious quenching was observed LT data shows a monotonic effect on lifetime with amount of PS added, although not nearly as negative an impact as in Blue. At 4:1 and 9:1 several samples are estimated to have t50˜900 hrs, compared to controls with t50˜1200 hrs. This result is close to the blue result of ˜30% LT decrease with 9:1 addition. Experimentation on the hole electron balance will likely find a longer lifetime architecture with higher amounts of PS.

### Example 8

Conditions similar to Example 6 were used, however, polyethylene oxide (PEO Mw˜1.7M) was used instead of PS, with 2.0, 5.0, and 10% w/w PEO in the emissive layer, respectively. PEO, while less-soluble in toluene, provides a much greater viscosity increase per unit added. PEO is also non-conducting.

The IV traces show that all of the devices have similar conductivity; the 49:1 samples have a bit higher current, which is attributed to a slightly thinner EML. The color coordinates in all devices were very similar ˜0.14, 0.133 (X,Y). The efficiency of the devices is scattered with PEO addition and annealing, perhaps because the EML thickness was not identical. Sample H, which was annealed, had a phase separation problem, likely because PEO has a low Tg. Post-fab annealing has been previously shown to improve lifetime, but leads to more shorting problems and generally lower power positively sloped CE vs V. LT data shows a monotonic effect on lifetime with amount of PEO added, except for the 49:1 samples, which are slightly better than the controls. The controls and 49:1 have an extrapolated t50˜1300 hrs, compared to 19:1 with t50˜200 hrs, and 9:1 at ˜10 hrs. Unlike PS, large loadings of PEO are quite detrimental to device LT perhaps because of morphology changes in the EML due to the low Tg of PEO.

### Example 9

Conditions similar to Example 6 were used, however, polydecene (PD) was used instead of PS, with ˜5.0, 10.0, and 20% w/w Polydecene in the emissive layer, respectively. Polydecene, an alkane type polymer will provide a higher excluded volume and broaden the window of additive chemistries.

The IV traces show increasing resistivity of the EML, excluding the 20:1 device D, with increasing amount of polydecene. Likely, the 20:1 sample has a slightly thinner EML. Interestingly, the higher PD loadings show greatly improved off-state current with increased loading. The X color coordinates in all devices were very similar ˜0.14, while the Y shifts monotonically from ˜0.14 to 0.16 with increasing PD loading. This is attributed to relocation of the recombination zone causing slight changes in the micro-cavity effect. The efficiency of the devices is pretty constant ˜5 cd/A with some scatter. LT data shows a monotonic effect on lifetime with amount of PD added. The controls have an extrapolated t50˜1300 hrs, compared to 20:1 with t50˜900 hrs, 10:1 at ˜750 hrs, and 4:1˜250 hrs. Like PS, large loadings of PD are detrimental to device LT, however, the quality of PD used in this experiment is unknown. Unlike PEO, addition of PS and PD is not catastrophic for device lifetime, indicating that morphology and Tg of the polymeric additive likely play a role in device lifetime.

### Example 10

Green devices were made using ˜10% polymer additive (H563) into our green EML (blue host and green dopant). Some devices were spun coated onto large pixels (5×5 mm), some devices were spun coated onto small pixels (˜200 um), and some devices were ink-jetted into small pixels. It was found that the leakage is better when polymer is added to the small mol EML, without losing much lifetime or color. Jettability is improved by just 10% additive. Data is shown in TABLE 3.

TABLE 3

| | | | Current | Leakage | Lifetime |
|---|---|---|---|---|---|
| | | CIE Color | Efficiency | current | hrs @ |
| Display | Type | Coordinate | Cd/Amp | uA | 1000 nits |
| A: Large backlight | control - no | 0.29, 0.64 | 15 +/− 3 | 50-400 | 2000-3000 |
| device; 5 × 5 mm | polymer | | | | |
| pixel; spin coated | additive | | | | |
| B: Large backlight | with 10% | 0.29, 0.64 | 15 +/− 3 | <10 | 2000-3000 |
| device; 5 × 5 mm | polymer | | | | |
| pixel; spin coated | additive | | | | |
| C: Small backlight | with 10% | 0.32, 0.62 | 13 +/− 3 | <50 | 2000-3000 |
| device; 200 um | polymer | | | | |
| pixel; spin coated | additive | | | | |
| D: Small backlight | with 10% | 0.32, 0.62 | 14 +/− 6 | <10 | 1000-2500 |
| device; 200 um | polymer | | | | |
| pixel; ink jetted | additive | | | | |

Also observed separately was that with <10%AEF2544 additive to blue EML, improved jettability and leakage was achieved without losing color coordinate.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Many aspects and embodiments have been described above and are merely exemplary and not limiting. After reading this specification, skilled artisans appreciate that other aspects and embodiments are possible without departing from the scope of the invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges include each and every value within that range.

1. A composition, comprising:
a small molecule active material;
polymer; and
aprotic solvent.

2. The composition of claim 1, wherein the small molecule active material is fluorescent.

3. The composition of claim 1, wherein the small molecule active material comprises at least one host and dopant.

4. The composition of claim 1, wherein the small molecule active material is present in a range of about 0.5 percent to about 30 percent by weight of the composition.

5. The composition of claim 1, wherein the small molecule active material is present in a range of about 1 percent to about 20 percent by weight of the composition.

6. The composition of claim 1, wherein the small molecule active material is present in a range of about 2 percent to about 10 percent by weight of the composition.

7. The composition of claim 1, wherein the polymer has a molecular weight of at least 100,000, and optionally, at least 200,000.

8. The composition of claim 1, wherein the polymer is one that avoids phase separation upon removal of the solvent.

9. The composition of claim 1, wherein the polymer is polyfluorene, polyspirofluorene, polystyrene, polyethylene, poly[2,2-diphenyl-(hexafluoroisopropylidene)-4,4′-diyl], polyspirofluorene AEF 2544, a copolymer of 2,2-diphenyl-(hexafluoroisopropylidene)-4,4′-diyl and a dialkyl fluorine, poly(vinylquinoxaline), or mixtures thereof.

10. The composition of claim 1, wherein the polymer is present in a range of about 1 percent to about 20 percent by weight of the composition.

11. The composition of claim 1, wherein the polymer is present in a range of about 5 percent to about 15 percent by weight of the composition.

12. The composition of claim 1, wherein the aprotic solvent is one that solubilizes both the small molecule emissive material and the polymeric additive in a stable blend.

13. The composition of claim 1, wherein the aprotic solvent is aromatic hydrocarbon, toluene, xylene, mesitylene, anisole, chlorobenzene, cyclohexanone, gamma-valerolactone, chloroform, derivatives thereof, or mixtures thereof.

14. The composition of claim 1, wherein the viscosity of the composition is in a range of about 0.1 to about 100 centipoise.

15. A method for improving the uniformity of an active layer containing small molecules, comprising:
adding a polymer to the active layer composition before deposition.

16. A method for improving the deposition of an active layer containing small molecules, comprising:
adding a polymer to the active layer composition before deposition.

17. An organic electronic device having an active layer including the composition of claim 1.

18. An article useful in the manufacture of an organic electronic device, comprising the composition of claim 1.
